(19) United States
(12) Patent Application Publication
(10) Pub. No.: US 2009/0301911 A1
(43) Pub. Date: Dec. 10, 2009

(54) Light weight clip on fishing fly case

(76) Inventor: Gary Lee Rubin, Birmingham, AL (US)

Correspondence Address: GARY L. RUBIN, 180 MAPLE TRACE, BIRMINGHAM, AL, 35244, US

(21) Appl. No.: 11/535,447

(22) Filed: Mar. 7, 2007

(51) Int. Cl. A01K 97/06

(52) U.S. Cl. 206/315.11; 224/269; 43/57.1

(57) ABSTRACT

A light weight soft fly case for holding fishing flies that can be clipped on or removed via an integrated rotatable clip, to a belt, harness, suspender or pocket that makes them readily accessible with one hand to the fisherman. The light weight soft fly case would be rectangular in shape, be made from nylon and neoprene, with a one piece case construction, and with a one handed hook and loop closure. The light weight soft fly case would include a nylon gusset hinge limiting the opening to a 90 degree angle for easy fly selection. The light weight soft fly case would include an attached but removable ripple foam insert for providing a surface upon which fishing flies might be secured. The light weight soft fly case may include a transparent cover for easy fly identification.

### 1. FIELD OF THE INVENTION

This invention relates to fishing accessories, and in particular as it relates to an apparatus that allows for removable storage and one handed accessibility to fishing flies that can be worn in various methods while fishing.

### 2. BACKGROUND OF THE INVENTION

Typically fishermen on streams and lakes want to carry a wide variety of fishing flies at their disposal, so that different types may be tried in a short period of time to be successful. The flies are generally held in a variety of types of fly boxes, which are relatively small, generally hinged closing and made of hard plastic. Fly fishermen generally carry four to six of these boxes, which are normally stored inside various fishing vests, clothing pockets or various bags or cases worn by the fisherman. While fishing it is necessary to carry a large number of flies and fly boxes, often changing these flies in a very short time which is a significant factor in the success of the fishing event.

Many problems arise from carrying a large variety of flies and fly boxes and there subsequent storage.

The number one factor to a fly fisherman is the need to quickly identify and secure the appropriate fly for the specific fishing conditions. When carrying a multitude of boxes it is necessary to determine which box contains the appropriate fly for the specific conditions at the time. Most of these boxes are opaque in design and must either be opened to identify the contents or be marked in a way to identify the contents.

In addition, many times these fly boxes are placed in very confined bags, pockets or vests that are often jammed full of other fishing accessories, making the selection and removal of the appropriate fly box difficult and time consuming. Additional important consideration for fly boxes is the relative ease of opening and closing of the box, particularly in cold weather, when dexterity is a problem. Generally these fly boxes are constructed with a hinge opening and are secured closed with a clasp or magnetic closure. Once the appropriate fly box is identified it must be opened, generally using two hands to open and support the box, the appropriate fly has to be removed, secured in the appropriate way, and then the box must be closed and placed back into the appropriate pocket, bag, or vest. All of these things take a great amount of time, and require careful attention and dexterity, as the fishermen are usually standing in a moving body of water or other distracting environment and normally holding a fishing rod.

Yet another consideration is the fact that these fly boxes can hold hundreds of dollars worth of flies, if one is dropped it can quickly sink or float away, thus causing substantial monetary loss, not to mention the loss of the flies for the remainder of the fishing event.

### 3. SUMMARY OF THE INVENTION

It is therefore an object of this invention to provide a means of organization, storage, and transportation of fishing flies that can be worn by a fisherman in a variety of positions and locations. It is a further object of this invention to provide a means of organization, storage, and transportation of fishing flies that can be accessed, opened, utilized, and closed easily with one hand.

It is a further object of this invention to provide a light weight means of organization and storage of fishing flies. It is a further object of this invention to provide an inexpensive means of organization and storage of fishing flies.

It is a further object of this invention to provide a method for the easy and immediate identification of the fishing flies being stored.

To achieve these and other objects and advantages the present invention discloses a device for holding fishing flies that can be clipped on or removed via an integrated rotatable clip, to a belt, harness, suspender or pocket that makes them readily accessible with one hand to the fisherman. The device would be made from fabric or neoprene, with a one piece case construction, and with a one handed hook and loop closure. The device would include an attached but removable ripple foam insert for providing a surface upon which fishing flies might be secured. The device would include a section with a transparent cover for easy fly identification.

### 4. BRIEF DESCRIPTION OF THE DRAWINGS

FIG. 1. is a perspective view of the embodiment of this invention a light weight clip on fishing fly case, partially open to show the interior construction.

FIG. 2. is a side view of the embodiment of this invention a light weight clip on fishing fly case, partially open to show the construction and side gusset.

FIG. 3. is a front view of this invention in the closed position.

FIG. 4. is a rear view of this invention in the closed position.

FIG. 5. is an open top view in contrast color of the invention showing the one piece construction prior to the addition of the side gusset.

### DESCRIPTION OF PREFERRED EMBODIMENT

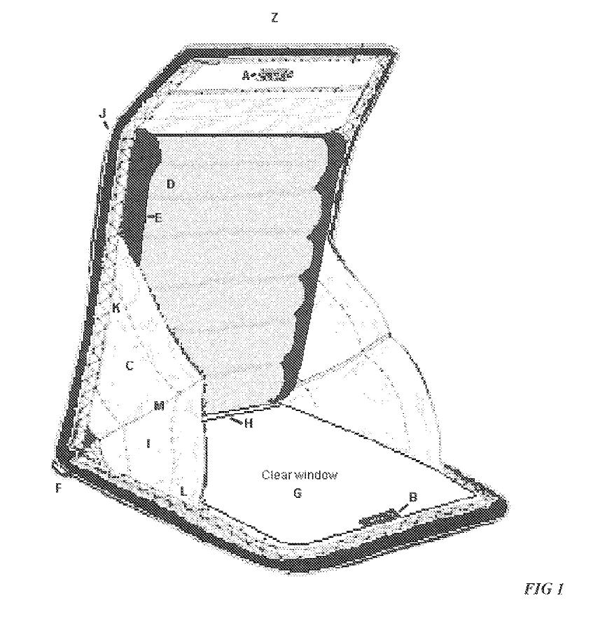

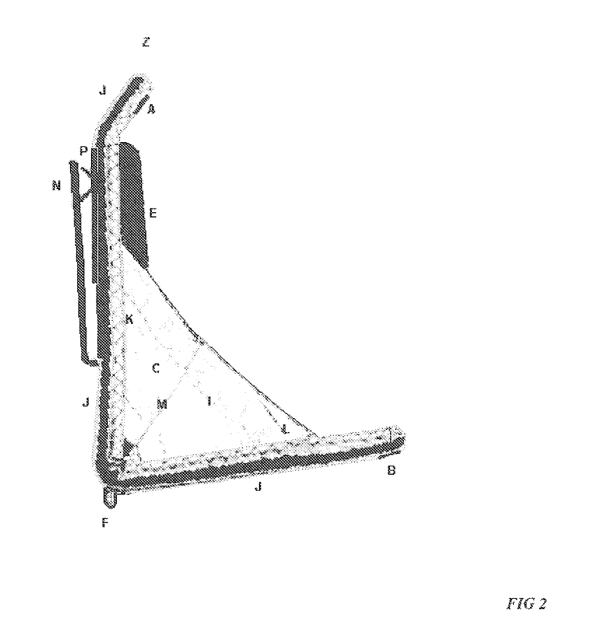

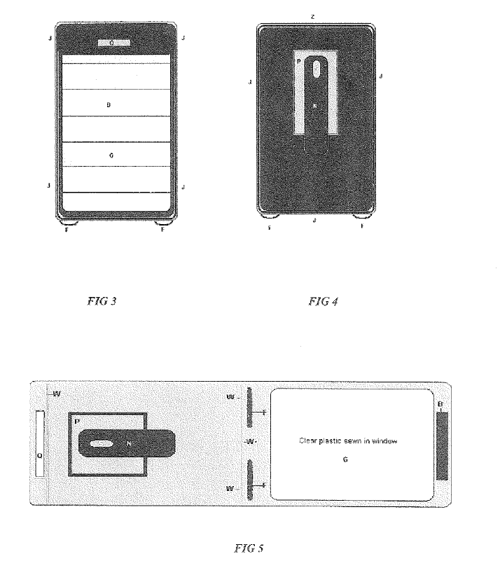

FIGS. 1-5 depicts a lightweight flycase, generally referred to as (Z) will be made of nylon, neoprene or another flexible, lightweight fabrication. The flycase (Z) will generally be of one piece construction that that will be able to be folded along seams (W) and held closed by hook and loop fasteners (A) placed along the upper inside portion of the flycase (Z) and (B) placed on the lower interior portion of the flycase (Z) as shown in FIG. 2. The flycase (Z) will have a clear plastic window (G) sewn into the bottom portion of the flycase (Z) as shown in FIGS. 1 and 5 so the fisherman can see the contents of the fly case without opening it. The flycase (Z) will have the ability to be attached to various parts of the fisherman's wardrobe, waders, or belt by a rotating clip (N), attached to the upper rear portion of the flycase (Z) as shown in FIGS. 2, 4, and 5. The flycase (Z) will include a rectangular panel (E) of a minimal thickness hard plastic material, having a pad of a foam or sponge like material, generally referred to as (D), and connected thereto. The material (D) is preferably a foam or sponge-like material suitable for holding fishing flies by removable piercing of the material by fishing hooks and thus providing a surface upon which fishing flies may be affixed while remaining readily accessible to the user. The material (D) is readily available in the market in standardized sizes with adhesive backing for attachment to the flycase (Z).

The rectangular panel (E) will be constructed in such a manner and size that these standardized replacement foam pads will fit with the two vertical sides of the panel. These vertical sides will be perpendicular to the rectangular panel (E) and be slightly taller than the thickness of the foam pad (D) and serve as a support for the flycase (Z) when closed and protect the fishing flies attached to foam pad (D). The general shape of panel (E) will be as the letter H, and will be attached to the back panel of the flycase (Z) by placing it between the back panel of the flycase (Z) and the adhesive side of the foam pad (D).

Flycase (Z) will be made of a one piece construction, generally rectangular in shape and approximately double the overall length of a standardized foam panel (D) with a relatively small extension at the top of the flycase (Z) which will enable the flycase (Z) to be folded over in half and have enough overlap with the bottom to close with attachments (A) and (B). By utilizing a one piece construction and the use of a lightweight neoprene or fabric for the flycase (Z) will ensure a very low cost alternative to the traditional fly box.

The flycase (Z) will be held open at approximately a 90 degree angle by a lightweight nylon fabric gusset, generally referred to as (M) and attached by sewing the triangular shaped fabric along the sides of the flycase (Z) along edges (K) and (L) on both sides of the flycase (Z) as shown in FIGS. 1 and 2. Each fabric gusset (M) will be constructed of two symmetrical pieces (C) and (I) sewn together at a 45 degree angle. The center seam of fabric gusset (M) will allow the gusset to fold inward or outward as the flycase is in the closed position.

The preferred embodiment flycase (Z) will include 2 web or nylon cord loops (F) attached permanently to the bottom of the flycase (Z) which will enable the user to attach various accessories or tools to the flycase (Z) thereby eliminating the need to wear additional bags, pockets, or cases.

I claim the invention is:

1. A light weight soft fly case for holding fishing flies adapted to be carried by a person and attached to a variety of articles of clothing, belts, straps, pockets or accessories at varying horizontal or vertical angles, to be accessible and opened or closed with one hand and comprising:
a unitary construction fabric or neoprene body case having an upper, middle and lower section, with each section having a height and width; hook and loop strip members attached to the inner portion of the upper section and the outer portion of the bottom section to allow said sections to be in a closed and secure position when upper section is folded over lower section; said middle section having attached by adhesive or hook and loop means to the inner portion, a pad of foam material for removably holding fishing flies by piercing engagement;
said middle section having attached by permanent means to the outer portion, a rotating gripping device for attaching said soft fly case to various articles of clothing or accessories at varying angles; said middle section and bottom section having attached by permanent means to a portion of each inside outer peripheral edge a fabric material thereby limiting the angle of fold between middle and lower sections to less than 90 degrees; said lower section to include an integrated transparent plastic window for identifying contents of middle section when in the folded and closed position.

2. A lightweight soft fly case of claim 1 and of unitary construction from fabric or neoprene construction having an upper, middle and lower section, with each section having a height and width.

3. A lightweight soft fly case of claim 2 and is constructed in such a way to include hook and loop strip members attached to the inner portion of the upper section and the outer portion of the bottom section to allow said sections to be in a closed and secure position when upper section is folded over lower section.

4. A lightweight soft fly case of claim 1 and is constructed in such a way to include said middle section having attached by permanent means to the outer portion, a rotating gripping device for attaching said soft fly case to various articles of clothing or accessories at varying angles.

5. A lightweight soft fly case of claim 2 and is constructed in such a way whereby said middle section is having attached by adhesive or hook and loop means to the inner portion, a pad of foam material for removably holding fishing flies by piercing engagement.

6. A lightweight soft fly case of claim 3 that is constructed in such a way that hook and loop strip members attached to the inner portion of the upper section and the outer portion of the bottom section allow said sections to be closed and secured by one hand.

7. A lightweight soft fly case of claim 6 that is characterized by the bottom section to be constructed in such a way to include a transparent window of plastic material which would allow when in the closed position, the contents of the foresaid middle section to be viewed without opening.
